(19) United States
(12) Patent Application Publication
(10) Pub. No.: US 2005/0175372 A1
(43) Pub. Date: Aug. 11, 2005

(54) Image forming apparatus

(75) Inventor: Hiroyuki Kunugi, Numazu-shi (JP)

Correspondence Address: FOLEY AND LARDNER;SUITE 500, 3000 K STREET NW, WASHINGTON, DC, 20007, US

(73) Assignee: KABUSHIKI KAISHA TOSHIBA and TOSHIBA TEC KABUSHIKI KAISHA

(21) Appl. No.: 10/774,447

(22) Filed: Feb. 10, 2004

(51) Int. Cl. G03G 15/00

(52) U.S. Cl. 399/107; 399/405

(57) ABSTRACT

An image forming apparatus includes an ejection space defined between the bottom of an image reading section and an image forming section and having an opening at the front of a main unit, an ejection tray cover defining the bottom of the ejection space and configured to receive a paper sheet ejected from the image forming section, the ejection tray cover covering the image forming section, a recess formed in the front portion of the ejection tray cover, and a front cover for opening and closing the front of the main unit, the front cover having an upper edge that cooperates with the recess to provide a handle section when the upper edge and the recess oppose each other.

### BACKGROUND OF THE INVENTION

The present invention relates to an image forming apparatus having an improved attachment structure for its control panel unit.

In image forming apparatuses, a photosensitive unit is provided in a main unit, and a toner image formed thereon is transferred onto a sheet of paper. The sheet of paper with the toner image transferred thereon is sent to a fixing unit, where it is heated and pressed to have the toner image fixed thereon. After fixing, the paper sheet is ejected into a paper ejection tray via an ejection roller.

In general, ejection trays are attached to side portions of the main unit such that they protrude outwardly. Accordingly, it is necessary to locate the main unit away from the wall by a distance corresponding to the protruding ejection tray, which means that a large installation space is required.

In light of this, an image forming apparatus has been recently developed which has a structure that enables the main unit to be located in contact with the wall. This structure incorporates an ejection space with an opening formed at the front of the main unit, and an ejection tray cover that receives paper sheets ejected from the image forming section and covers the upper portion of the image forming section.

Thus, the above image forming apparatus comprises the main unit having the image forming section for forming an image on a paper sheet; an image reading section provided above the main unit, separate from the image forming section, for reading the image; the ejection space provided between the bottom of the image reading section and the image forming section and having the opening formed at the front of the main unit; and the ejection tray cover that receives paper sheets ejected from the image forming section and covers the upper portion of the image forming section.

This image forming apparatus further comprises a control panel unit provided at the front of the image reading section for controlling the image forming operation.

Further, a conveyance unit for conveying, when necessary, ejected paper sheets to an optional device, such as a sorting/stacking device, can be attached to and detached from the ejection space.

However, in the prior art, since the control panel unit is fixedly attached to the ejection space such that it blocks the front of the ejection space, an operator cannot open the ejection tray, which is inconvenient.

Further, when the main unit is located very close to the wall, the wall-side handle portion cannot be grasped, therefore the front cover cannot be opened.

Furthermore, if an optional device, for example, is provided adjacent to the main unit, the handle portion cannot be grasped, too, and the front cover cannot be opened.

### BRIEF SUMMARY OF THE INVENTION

The present invention has been developed under the above-described circumstances, and aims to provide an image forming apparatus, in which the front cover can be easily opened even by one hand, and can be opened even if the apparatus is installed very close to the wall, or an optional device is installed adjacent to the apparatus.

An image forming apparatus according to an aspect of the invention comprises: a main unit having an image forming section configured to form an image on a paper sheet; an image reading section located just above the main unit, and configured to read a document image; an ejection space defined between a bottom of the image reading section and the image forming section, the ejection space having an opening at a front of the main unit; an ejection tray cover defining a bottom of the ejection space and configured to receive a paper sheet ejected from the image forming section, the ejection tray cover covering the image forming section; a recess formed in a front portion of the ejection tray cover; and a front cover configured to open and close a front of the main unit, the front cover having an upper edge, the upper edge and the recess cooperating with each other to provide a handle section when the upper edge and the recess oppose each other.

Additional objects and advantages of the invention will be set forth in the description which follows, and in part will be obvious from the description, or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a perspective view illustrating the outward appearance of an image forming apparatus according to a first embodiment of the invention;

FIG. 2 is a perspective view illustrating the outward appearance of the image forming apparatus as viewed at a different angle;

FIG. 3 is a view illustrating the internal structure of the image forming apparatus;

FIG. 4 is an expanded perspective view illustrating the front section of the image forming apparatus;

FIG. 5 is a side sectional view illustrating the attachment structure of a front cover incorporated in the image forming apparatus;

FIG. 6 is a sectional view illustrating the relationship between a recess formed in an ejection tray cover incorporated in the image forming apparatus and the upper edge of the front cover; and

FIG. 7 is a view illustrating a state in which the front cover of the image forming apparatus is open.

### DETAILED DESCRIPTION OF THE INVENTION

Embodiments of the invention will be described in detail with reference to the accompanying drawings.

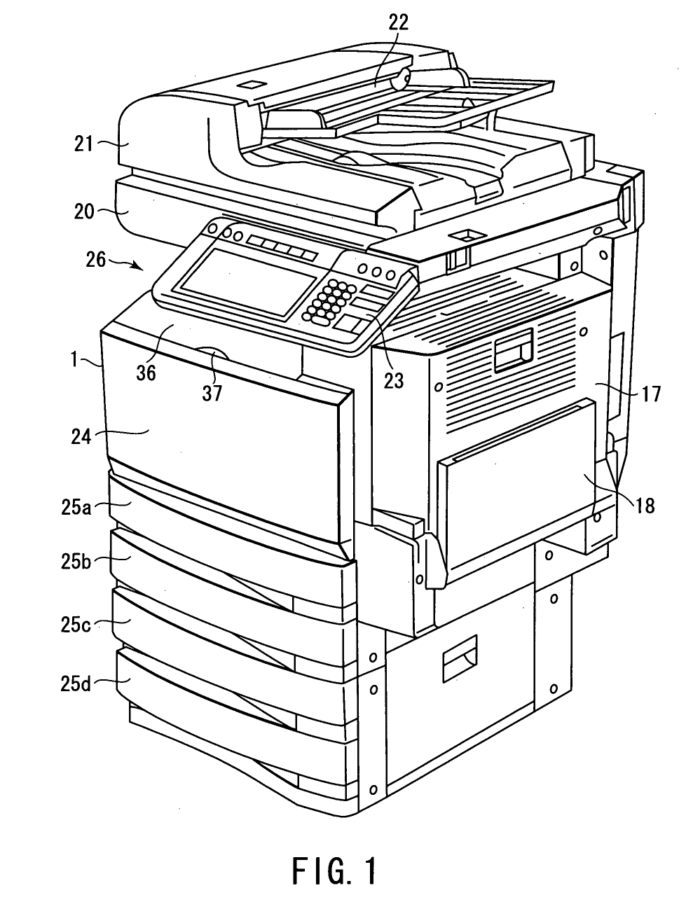

FIG. 1 is a perspective view illustrating an image forming apparatus according to a first embodiment of the invention.

The image forming apparatus has a main unit 1, and an optical reading unit 20 as an image reading section for optically reading a document is provided above the main unit 1. An automatic feeding unit 21 for automatically feeding a document to the image reading section is provided on the upper portion of the reading unit 20. A control panel unit 23 for controlling the image forming operation of the image forming apparatus is provided on the front surface of the reading unit 20.

A front cover 24 for opening the main unit 1 when necessary is provided so that it can be opened and closed. A plurality of paper feed cassettes 25a to 25d are provided at the lower portion of the main unit 1 so that they can be pulled out of and pushed into the main unit.

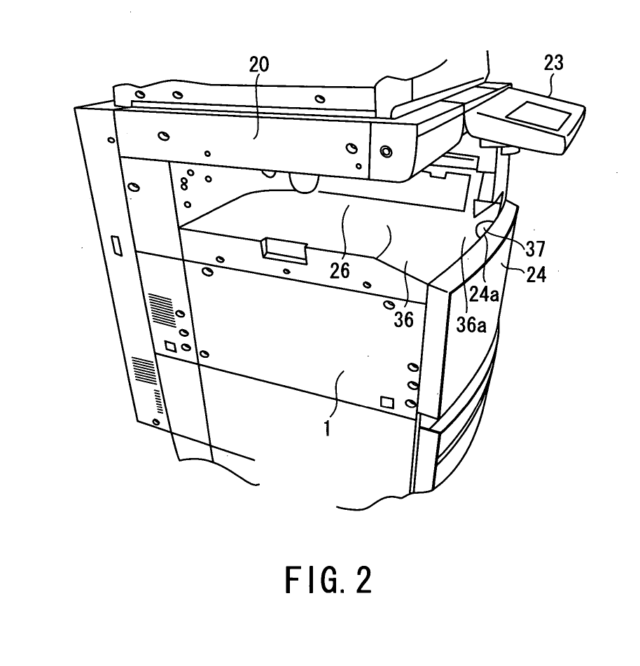

Further, between the upper surface of the main unit 1 and the lower surface of the reading unit 20, there are provided an ejection space 26 having an opening formed at the front of the main unit 1 as also shown in FIG. 2, and an ejection tray cover 36 defining the bottom of the ejection space 26. The ejection tray cover is used to receive a paper sheet ejected from an image forming mechanism 1A, as the image forming section, covering the upper portion of the image forming mechanism 1A.

An operator can take paper sheets out of the ejection tray cover 36 through the front opening of the ejection space 26.

The ejection tray cover 36, which has a function for covering the upper portion of the image forming mechanism 1A and a function for receiving ejected paper sheets and stacking them, may be formed of a plurality of components or a single component.

Further, an optional device (not shown) for, for example, sorting and stacking paper sheets with images formed thereon may be provided adjacent to one-side surface of the main unit 1.

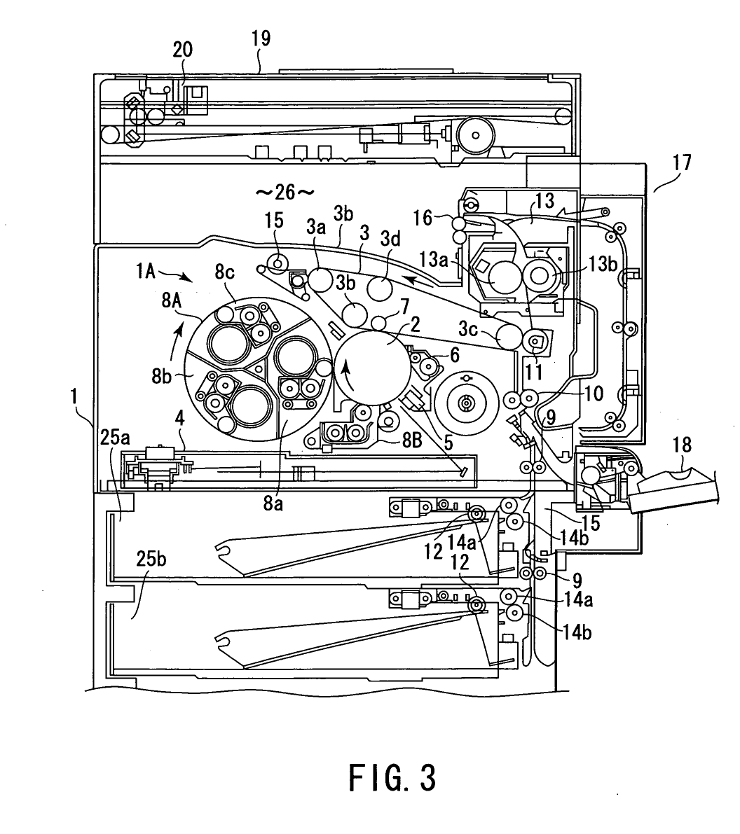

FIG. 3 illustrates the internal structure of the main unit 1.

The main unit 1 contains the image forming mechanism 1A as an image forming section. The image forming mechanism 1A comprises a photosensitive drum 2, a charger unit 5 for keeping the photosensitive drum 2 at a predetermined potential, and an exposure unit 4 for forming an electrostatic latent image on the charged photosensitive drum 2.

The image forming mechanism 1A further comprises a rotary developing unit 8A for color images, and a developing unit 8B for monochrome images that can be separated from the drum. The developing units supply toners as developers to electrostatic latent images formed on the photosensitive drum 2 by the exposure unit 4, thereby visualizing the latent images. The rotary developing unit 8A has a first developing section 8a for supplying yellow toner, a second developing section 8b for supplying cyan toner, and a third developing section 8c for supplying magenta toner. The image forming mechanism 1A further comprises an intermediate transfer belt 3 for temporarily holding a toner image formed on the photosensitive drum 2 by the developing unit 8A or 8B. The image forming mechanism 1A also comprises a cleaner 15 for cleaning the intermediate transfer belt 3, and a cleaning unit 6 for removing the toner remaining on the photosensitive drum 2.

The intermediate transfer belt 3 is stretched between the first to fourth rollers 3a to 3d with a predetermined tension. The portion of the intermediate transfer belt 3 that is stretched between the second and third rollers 3b and 3c is in contact with the periphery of the photosensitive drum 2. Further, a primary transfer roller 7 is in pressure contact with the upper portion of the photosensitive drum 2, with the intermediate transfer belt 3 interposed therebetween.

Respective pickup rollers 12 for picking paper sheets from the paper feed cassettes 25a to 25d are provided below the image forming mechanism 1A. Paper sheets picked by each pickup roller 12 are fed one by one by a paper feed roller 14a and separation roller 14b. A conveyance system 15 for conveying paper sheets to the intermediate transfer belt 3 is provided between the paper feed cassettes 25a to 25d and the intermediate transfer belt 3.

The conveyance system 15 comprises a conveyance roller 9, aligning roller 10, secondary transfer roller 11 arranged in this order in the paper conveyance direction. The aligning roller 10 temporarily stops each paper sheet fed thereto, thereby correcting the inclination of each paper sheet with respect to the conveyance direction. Further, the aligning roller aligns the leading edge of each paper sheet with the leading edge of a toner image on the intermediate transfer belt 3.

A fixing unit 13 for fixing a toner image, transferred to each paper sheet, on each sheet is provided downstream of the secondary transfer roller 11 with respect to the conveyance direction. The fixing unit 13 is formed of a heating roller 13a and pressing roller 13b. Ejection rollers 16 for ejecting each paper sheet onto the ejection tray cover 36 located below the ejection space 26 are provided downstream of the fixing unit 13 with respect to the conveyance direction.

A reversing unit 17 used for double-sided copying and a manual feeder 18 used for manually feeding paper sheets are provided at the other side of the main unit 1.

The image forming operation of the above-described image forming apparatus will now be described.

Image information of a document placed on the document table 19 is optically read by the optical reading unit 20. At this time, the surface of the photosensitive drum 2 is uniformly charged by the charger unit 5, and an electrostatic latent image corresponding to the image information is formed on the charged photosensitive drum 2 by the exposure unit 4. The latent image is sent to the developing unit 8B or 8A in accordance with the rotation of the photosensitive drum 2 and developed by black toner or color toners supplied thereto from the developing unit. The developed toner image is primarily transferred onto the intermediate belt 3 by the primary transfer roller 7 in accordance with the rotation of the photosensitive drum 2. After passing through the transfer region, the photosensitive drum 2 is optically deelectrified by a deelectrifier (not shown), and the toner remaining thereon is cleaned by the cleaner 6.

At this time, a paper sheet is fed from the paper feed cassette 25a (to 25d) into the clearance between the intermediate transfer belt 3 and secondary transfer roller 11. Onto this paper sheet, the toner image on the intermediate transfer belt 3 is secondarily transferred. After transfer, the paper sheet is separated from the intermediate transfer belt 3 and sent to the fixing unit 13, where the toner image is heated, pressed and fixed on the sheet. After fixing, the paper sheet is sent to the outside by the ejection rollers 16, and ejected onto the ejection tray cover 36.

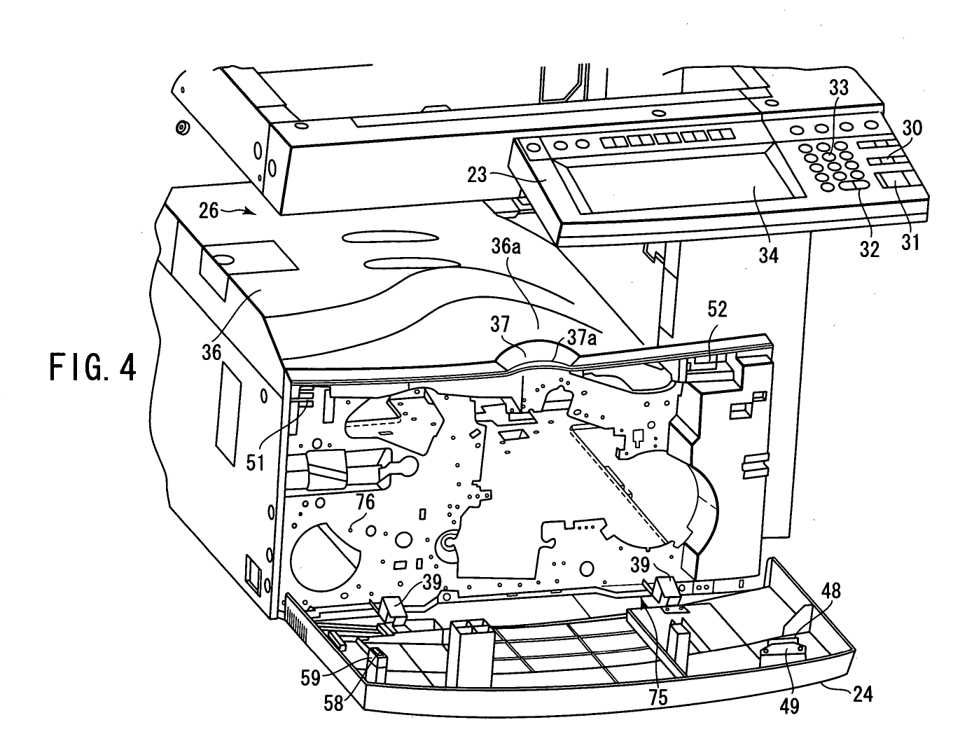

FIG. 4 is an enlarged perspective view illustrating the above-described control panel unit 23, ejection tray cover 36 and front cover 24.

The ejection tray cover 36 that receives paper sheets ejected from the ejection rollers 16 and covers the upper portion of the image forming section defines the bottom of the ejection space 26. The ejection tray cover 36 has an angled portion 36a downwardly inclining toward the front of the main unit 1, which enables paper sheets ejected on the ejection tray cover 36 to be easily held.

Further, in a front end portion of the angled portion 36a of the ejection tray cover 36, a recess 37 is formed at a position corresponding to the substantially middle portion of the front cover 24 in the width direction, such that the recess 37 is downwardly and gently curved to its bottom 37a. The recess 37 permits an operator to insert their fingers to open the front cover 24 and hook the upper edge 24a, described later, of the front cover 24. The recess 37 of the ejection tray cover 36 is located at the front end of the angled portion 36a between first and second magnets 48 and 58, described later, incorporated in the front cover 24.

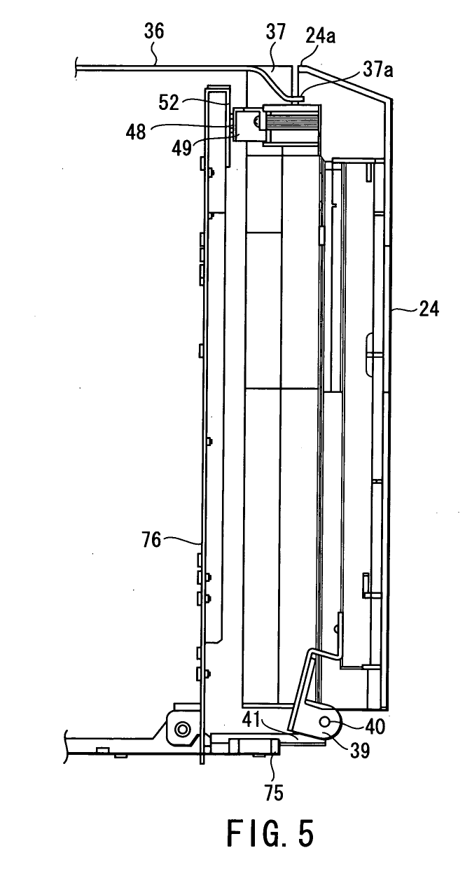

As shown in FIGS. 4 and 5, the front cover 24 has its opposite lower end portions pivotably attached to the base frame 75 of the main unit 1 by cover-side hinges 39, shaft 40 and main-unit-side hinges 41. A first magnet 48, as a first holder, is attached to an upper end portion of the front cover 24 with an attachment member 49 interposed therebetween, while a second magnet 58, as a second holder, is attached to another upper end portion with an attachment member 59 interposed therebetween.

First and second iron plates 51 and 52 as holding means to be magnetically engaged with the first and second magnets, respectively, are provided at opposite upper end portions of a front frame 76 incorporated in the main unit 1. When the front cover 24 is upwardly rotated, the first and second magnets 48 and 58 are magnetically engaged with the first and second iron plates 51 and 52, respectively, thereby holding the front cover in the closed position.

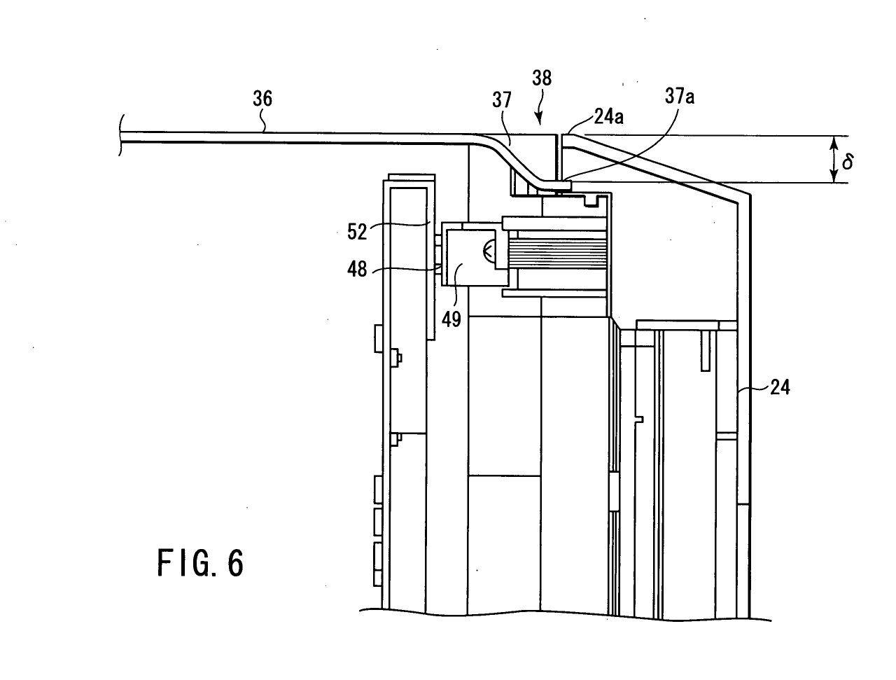

When the front cover 24 is closed, the upper edge 24a is positioned in front of the ejection tray cover 36, as is also shown in FIG. 6. In other words, the upper edge 24a of the front cover 24 opposes the recess 37 of the ejection tray cover 36, thereby providing an attachment section 38. The depth of the attachment section 38 corresponds to the vertical dimension 6 between the upper edge 24a of the front cover 24 and the bottom 37a of the recess 37. The dimension 6 is set to 0.3 mm or more (preferably, 2 mm), which enables an operator to easily and reliably hook the upper edge 24a of the front cover 24.

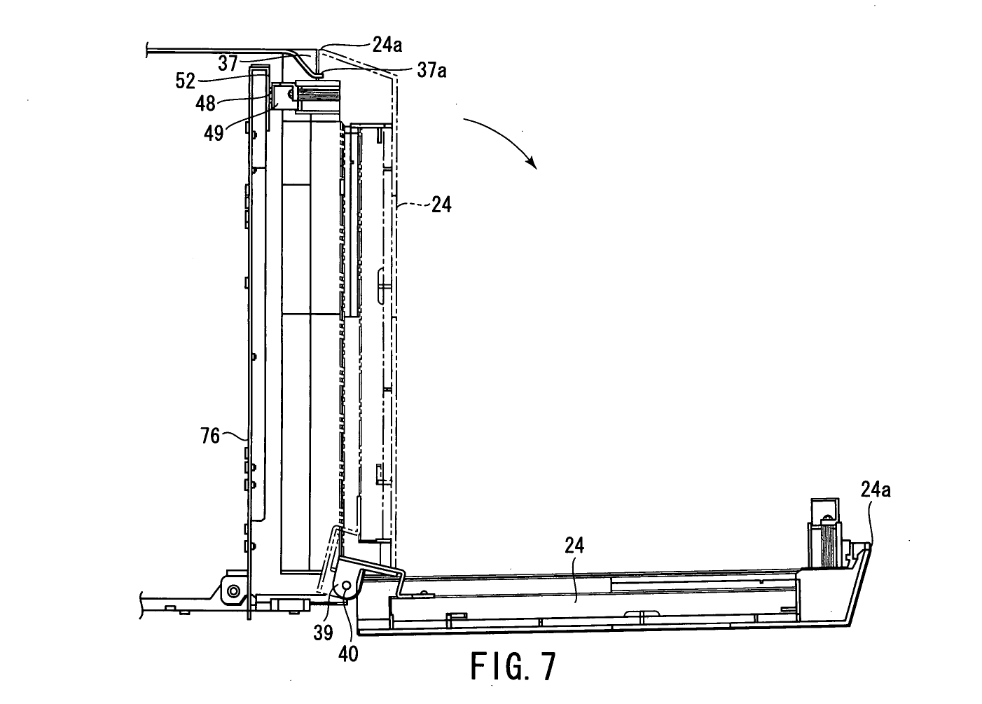

To open the front cover 24, the operator inserts their fingers into the recess 37 of the ejection tray cover 36, hooks the upper edge 24a of the front cover 24, and pulls the front cover 24. As a result, the first and second magnets 48 and 58 are separated from the first and second iron plates 51 and 52 against the magnetic forces exerted therebetween, thereby opening the front cover 24 as shown in FIG. 7.

As described above, in the embodiment, a recess 37 is formed in the front portion of the ejection tray cover 36, and fingers are inserted into the recess 37 to hook the upper edge of the front cover 24. This structure enables an operator to open the front cover 24 by one hand even if the other hand holds a baggage. Thus, the usability is enhanced.

Moreover, even if an optional device is installed adjacent to one side of the main unit 1, the front cover 24 can be opened by inserting fingers into the recess 37 formed in the front portion of the ejection tray cover 36, and hooking the upper edge 24a of the front cover 24 by the inserted fingers. In addition, even if the main unit 1 is installed with its one side positioned very close to the wall, the front cover 24 can be opened in the same manner as the above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image forming apparatus comprising:
a main unit having an image forming section configured to form an image on a paper sheet;
an image reading section located just above the main unit, and configured to read a document image;
an ejection space defined between a bottom of the image reading section and the image forming section, the ejection space having an opening at a front of the main unit;
an ejection tray cover defining a bottom of the ejection space and configured to receive a paper sheet ejected from the image forming section, the ejection tray cover covering the image forming section;
a recess formed in a front portion of the ejection tray cover; and
a front cover configured to open and close a front of the main unit, the front cover having an upper edge, the upper edge and the recess cooperating with each other to provide a handle section when the upper edge and the recess oppose each other.

2. The image forming apparatus according to claim 1, wherein the recess opposes a substantially middle portion of the front cover in a width direction thereof.

3. The image forming apparatus according to claim 1, wherein; the front cover has a first holder at an end portion and a second holder at another end portion, the first and second holders forming holding means for holding the front cover on the main unit; and
the recess is located between the first and second holders of the front cover.

4. The image forming apparatus according to claim 1, wherein a vertical distance between an upper edge of the front cover and a bottom of the recess is not less than 0.3 mm.

5. The image forming apparatus according to claim 2, wherein a vertical distance between an upper edge of the front cover and a bottom of the recess is not less than 0.3 mm.

6. The image forming apparatus according to claim 3, wherein a vertical distance between an upper edge of the front cover and a bottom of the recess is not less than 0.3 mm.
